(19) United States
(12) Patent Application Publication
(10) Pub. No.: US 2023/0379915 A1
(43) Pub. Date: Nov. 23, 2023

(54) UPLINK CONTROL INFORMATION (UCI) MULTIPLEXING FOR MULTI-SLOT PHYSICAL UPLINK SHARED CHANNEL (PUSCH) WITH TRANSPORT BLOCK SIZE (TBS) SCALING

(71) Applicant: QUALCOMM Incorporated, San Diego, CA (US)

(72) Inventors: Jing DAI, Beijing (CN); Chao WEI, Beijing (CN); Chenxi HAO, Beijing (CN); Qiaoyu LI, Beijing (CN); Min HUANG, Beijing (CN); Wei XI, Beijing (CN); Hao XU, Beijing (CN); Gokul SRIDHARAN, Sunnyvale, CA (US); Hung Dinh LY, San Diego, CA (US); Enoch Shiao-Kuang LU, San Diego, CA (US)

(21) Appl. No.: 17/924,615

(22) PCT Filed: Jul. 3, 2020
(86) PCT No.: PCT/CN2020/100102

§ 371 Date: Nov. 10, 2022

(51) Int. Cl. H04W 72/21; H04L 1/00; H04L 1/1607; H04W 72/0446; H04L 1/1812

(52) U.S. Cl. CPC H04W 72/21; H04L 1/0073; H04L 1/1664; H04W 72/0446; H04L 1/1812

(57) ABSTRACT

The present disclosure relates to uplink control information (UCI) multiplexing for multi-slot physical uplink shared channel (PUSCH) with transport block size (TBS) scaling. Specifically, a user equipment (UE) may determine to transmit UCI on a multi-slot PUSCH transmission. The UE may further identify a number of UCI resource elements (REs) in at least one slot of the PUSCH transmission based at least on a scaling rate. The UE may further perform the PUSCH transmission including the UCI REs.

### BACKGROUND

Aspects of the present disclosure relate generally to wireless communication systems, and more particularly, to uplink control information (UCI) multiplexing for multi-slot physical uplink shared channel (PUSCH) with transport block size (TBS) scaling.

Wireless communication systems are widely deployed to provide various types of communication content such as voice, video, packet data, messaging, broadcast, and so on. These systems may be multiple-access systems capable of supporting communication with multiple users by sharing the available system resources (such as time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems, and single-carrier frequency division multiple access (SC-FDMA) systems.

These multiple access technologies have been adopted in various telecommunication standards to provide a common protocol that enables different wireless devices to communicate on a municipal, national, regional, and even global level. For example, a fifth generation (5G) wireless communications technology (which can be referred to as NR) is envisaged to expand and support diverse usage scenarios and applications with respect to current mobile network generations. In some aspects, 5G communications technology can include: enhanced mobile broadband (eMBB) addressing human-centric use cases for access to multimedia content, services and data; ultra-reliable-low latency communications (URLLC) with certain specifications for latency and reliability; and massive machine type communications (mMTC), which can allow a very large number of connected devices and transmission of a relatively low volume of non-delay-sensitive information.

For example, for various communications technology such as, but not limited to NR, some implementations may increase transmission speed and flexibility but also transmission complexity. Thus, improvements in wireless communication operations may be desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

An example implementation includes a method of wireless communication at a user equipment (UE) including determining to transmit uplink control information (UCI) on a multi-slot physical uplink shared channel (PUSCH) transmission. The method further includes identifying a number of UCI resource elements (REs) in at least one slot of the PUSCH transmission based at least on a scaling rate. The method further includes performing the PUSCH transmission including the UCI REs.

In a further example, an apparatus for wireless communication is provided that includes a transceiver, a memory configured to store instructions, and one or more processors communicatively coupled with the transceiver and the memory. The one or more processors are configured to execute the instructions to perform the operations of the methods described herein. In another aspect, an apparatus for wireless communication is provided that includes means for performing the operations of methods described herein. In yet another aspect, a non-transitory computer-readable medium is provided including code executable by one or more processors to perform the operations of the methods described herein.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 illustrates an example of a wireless communication system.

FIG. 2 is a block diagram illustrating an example of a network entity (also referred to as a base station).

FIG. 3 is a block diagram illustrating an example of a user equipment (UE).

FIG. 4A is an example representation of a multi-slot physical uplink shared channel (PUSCH).

FIG. 4B is an example representation of multiple transmit time interval (TTI) slot formats and a redundancy value (RV) mapping.

FIG. 5A illustrates an example representation of uplink control information (UCI) multiplexed on a PUSCH transmission.

FIG. 5B illustrates various example UCI multiplexing scenarios for different scaling rates.

FIG. 5C illustrates an example rate matching pattern for a transmission in a slot.

FIG. 5D illustrates an example UCI multiplexing scheme for a continuous mapping scenario.

FIG. 6 is a flowchart of an example method of wireless communication at a UE.

FIG. 7 is a block diagram illustrating an example of a multiple-input and multiple-output (MIMO) communication system including a base station and a UE.

Like reference numbers and designations in the various drawings indicate like elements.

An Appendix is included that is part of the present application and provides additional details related to the various aspects of the present disclosure.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

The described features generally relate to uplink control information (UCI) multiplexing for multi-slot physical uplink shared channel (PUSCH) with transport block size (TBS) scaling. Specifically, in 5G new radio (NR), repeated transmission of PUSCH over successive slots (i.e., slot-repetition, aggregation, or multi-slot PUSCH) may be supported to increase the signal-to-noise ratio (SNR) for transmission reliability. For example, PUSCH repetition may be applied to coverage limited scenarios. When PUSCH transmissions are repeated to enhance coverage, a modulation coding scheme (MCS) with quadrature phase shift keying (QPSK) may be used as higher modulation orders (e.g., 16 quadrature amplitude modulation (QAM) or 64 QAM) have a lower radio frequency power efficiency. For example, a user equipment (UE) may be allowed to reduce the maximum output power due to higher order modulations, and the maximum power reduction (MPR) values for 16 QAM and 64 QAM are larger than QPSK. In particular, even for a maximum supported indicated code rate of ‘R’ (−0.67) for QPSK, the associated effective code rate (R_{eff}) of a 4-slot PUSCH (e.g., R_{eff}=R/4) or an 8-slot PUSCH (e.g., R_{eff}=R/8) may be very low.

However, for uplink coverage limited scenario, where the transmission power of the UE may be the cause of a bottleneck, an increase of bandwidth by a very low R_{eff} may not improve the transmission reliability, but only cost more resources. For instance, the combined gain of a lower R_{eff} is offset by the increased noise power due to a higher bandwidth, which may render the additional bandwidth effectively unusable. Therefore, for system capacity improvement, TBS or MCS scaling may be implemented for multi-slot PUSCH. In an example, a code rate or TBS may be scaled up for a four-slot PUSCH (e.g., scaled by a factor of 2 or 4).

Furthermore, in order to maintain a low peak to average power ratio (PAPR) characteristic, a UE may not be expected to transmit two uplink channels or signals simultaneously on a same carrier. If a single-slot PUCCH partially or fully overlaps with a single-slot PUSCH, the UE can multiplex the UCI onto the PUSCH transmission (e.g., upon satisfaction of certain conditions such as timeline requirement). Specifically, for multi-slot PUSCH, if one of the PUSCH transmissions in one slot overlaps with a single-slot PUCCH, and the multiplexing conditions are satisfied, the UCI may be multiplexed on the PUSCH transmission in that slot. For multi-slot PUSCH transmissions with TBS or MCS scaling, the TBS may be scaled up. However, as the scaling rate increases, the number of UCI resource elements (REs) may get smaller, resulting in potential loss of UCI transmission reliability on PUSCH.

Hence, to mitigate the loss of UCI transmission reliability on PUSCH, the present implementations provide for UCI multiplexing for multi-slot PUSCH based on TBS scaling. Specifically, a UE may determine to transmit UCI on a multi-slot PUSCH transmission. The UE may further identify a number of UCI REs in at least one slot of the PUSCH transmission based at least on a scaling rate. The UE may further perform the PUSCH transmission including the UCI REs. Particular implementations of the subject matter described in this disclosure can be implemented to realize one or more of the following potential advantages. The present aspects set forth techniques for improving UCI PUSCH transmissions.

As used in this application, the terms “component,” “module,” “system” and the like are intended to include a computer-related entity, such as but not limited to hardware, software, a combination of hardware and software, or software in execution. For example, a component may be, but is not limited to being, a process running on a processor, a processor, an object, an executable, a thread of execution, a program, or a computer. By way of illustration, both an application running on a computing device and the computing device can be a component. One or more components can reside within a process or thread of execution and a component can be localized on one computer or distributed between two or more computers. In addition, these components can execute from various computer readable media having various data structures stored thereon. The components can communicate by way of local or remote processes such as in accordance with a signal having one or more data packets, such as data from one component interacting with another component in a local system, distributed system, or across a network such as the Internet with other systems by way of the signal. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Techniques described herein may be used for various wireless communication systems such as CDMA, TDMA, FDMA, OFDMA, SC-FDMA, and other systems. The terms “system” and “network” may often be used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. U IRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (such as LTE) communications over a shared radio frequency spectrum band. The description below, however, describes an LTE/LTE-A system for purposes of example, and LTE terminology is used in much of the description below, although the techniques are applicable beyond LTE/LTE-A applications (such as to fifth generation (5G) NR networks or other next generation communication systems).

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

Various aspects or features will be presented in terms of systems that can include a number of devices, components, modules, and the like. It is to be understood and appreciated that the various systems can include additional devices, components, modules, etc. or may not include all of the devices, components, modules etc. discussed in connection with the figures. A combination of these approaches also can be used.

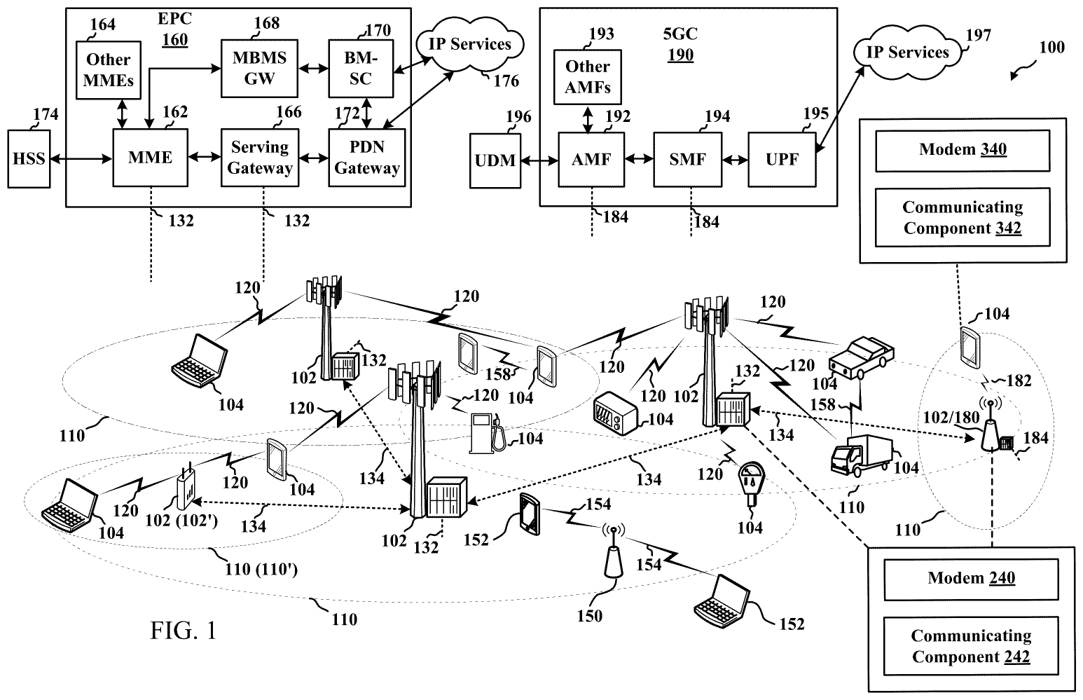

FIG. 1 illustrates an example of a wireless communication system. The wireless communications system (also referred to as a wireless wide area network (WWAN)), includes an access network 100, base stations 102, UEs 104, an Evolved Packet Core (EPC) 160, or a 5G Core (5GC) 190. The base stations 102, which also may be referred to as network entities, may include macro cells (high power cellular base station) or small cells (low power cellular base station). The macro cells can include base stations. The small cells can include femtocells, picocells, and microcells. In an example, the base stations 102 also may include gNBs 180, as described further herein.

In one example, some nodes such as base station 102/gNB 180, may have a modem 240 and communicating component 242 for transmitting, to a UE 104, various data, as described herein. Though a base station 102/gNB 180 is shown as having the modem 240 and communicating component 242, this is one illustrative example, and substantially any node may include a modem 240 and communicating component 242 for providing corresponding functionalities described herein.

In another example, some nodes such as UE 104 of the wireless communication system may have a modem 340 and communicating component 342 for multiplexing UCI with a multi-slot PUSCH transmission based on a scaling rate, as described herein. Though a UE 104 is shown as having the modem 340 and communicating component 342, this is one illustrative example, and substantially any node or type of node may include a modem 340 and communicating component 342 for providing corresponding functionalities described herein.

The base stations 102 configured for 4G LTE (which can collectively be referred to as Evolved Universal Mobile Telecommunications System (UMTS) Terrestrial Radio Access Network (E-UTRAN)) may interface with the EPC 160 through backhaul links 132 (such as using an S1 interface). The base stations 102 configured for 5G NR (which can collectively be referred to as Next Generation RAN (NG-RAN)) may interface with 5GC 190 through backhaul links 184. In addition to other functions, the base stations 102 may perform one or more of the following functions: transfer of user data, radio channel ciphering and deciphering, integrity protection, header compression, mobility control functions (such as handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (such as through the EPC 160 or 5GC 190) with each other over backhaul links 134 (such as using an X2 interface). The backhaul links 132, 134 or 184 may be wired or wireless.

The base stations 102 may wirelessly communicate with one or more UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be referred to as a heterogeneous network. A heterogeneous network also may include Home Evolved Node Bs (eNBs) (HeNBs), which may provide service to a restricted group, which can be referred to as a closed subscriber group (CSG). The communication links 120 between the base stations 102 and the UEs 104 may include uplink (UL) (also referred to as reverse link) transmissions from a UE 104 to a base station 102 or downlink (DL) (also referred to as forward link) transmissions from a base station 102 to a UE 104. The communication links 120 may use multiple-input and multiple-output (MIMO) antenna technology, including spatial multiplexing, beamforming, or transmit diversity. The communication links may be through one or more carriers. The base stations 102/UEs 104 may use spectrum up to Y MHz (such as 5, 10, 15, 20, 100, 400, etc. MHz) bandwidth per carrier allocated in a carrier aggregation of up to a total of Yx MHz (such as for x component carriers) used for transmission in the DL or the UL direction. The carriers may or may not be adjacent to each other. Allocation of carriers may be asymmetric with respect to DL and UL (such as more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

In another example, certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to or increase capacity of the access network.

A base station 102, whether a small cell 102′ or a large cell (such as macro base station), may include an eNB, gNodeB (gNB), or other type of base station. Some base stations, such as gNB 180 may operate in a traditional sub 6 GHz spectrum, in millimeter wave (mmW) frequencies, or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station, which may correspond to gNB 180, may utilize beamforming 182 with the UE 104 to compensate for the extremely high path loss and short range. A base station 102 referred to herein can include a gNB 180.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The 5GC 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 can be a control node that processes the signaling between the UEs 104 and the 5GC 190. Generally, the AMF 192 can provide QoS flow and session management. User Internet protocol (IP) packets (such as from one or more UEs 104) can be transferred through the UPF 195. The UPF 195 can provide UE IP address allocation for one or more UEs, as well as other functions. The UPF 195 is connected to the IP Services 197. The IP Services 197 may include the Internet, an intranet, an IP Multimedia Subsystem (IMS), a PS Streaming Service, or other IP services.

The base station also may be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or 5GC 190 for a UE 104. Examples of UEs 104 include a cellular phone, a smart phone, a session initiation protocol (SIP) phone, a laptop, a personal digital assistant (PDA), a satellite radio, a positioning system (such as satellite, terrestrial), a multimedia device, a video device, a digital audio player (such as MP3 player), a camera, a game console, a tablet, a smart device, robots, drones, an industrial/manufacturing device, a wearable device (such as a smart watch, smart clothing, smart glasses, virtual reality goggles, a smart wristband, smart jewelry (such as a smart ring, a smart bracelet)), a vehicle/a vehicular device, a meter (such as parking meter, electric meter, gas meter, water meter, flow meter), a gas pump, a large or small kitchen appliance, a medical/healthcare device, an implant, a sensor/actuator, a display, or any other similar functioning device. Some of the UEs 104 may be referred to as IoT devices (such as meters, pumps, monitors, cameras, industrial/manufacturing devices, appliances, vehicles, robots, drones, etc.). IoT UEs may include MTC/enhanced MTC (eMTC, also referred to as CAT-M, Cat M1) UEs, NB-IoT (also referred to as CAT NB1) UEs, as well as other types of UEs. In the present disclosure, eMTC and NB-IoT may refer to future technologies that may evolve from or may be based on these technologies. For example, eMTC may include FeMTC (further eMTC), eFeMTC (enhanced further eMTC), mMTC (massive MTC), etc., and NB-IoT may include eNB-IoT (enhanced NB-IoT), FeNB-IoT (further enhanced NB-IoT), etc. The UE 104 also may be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

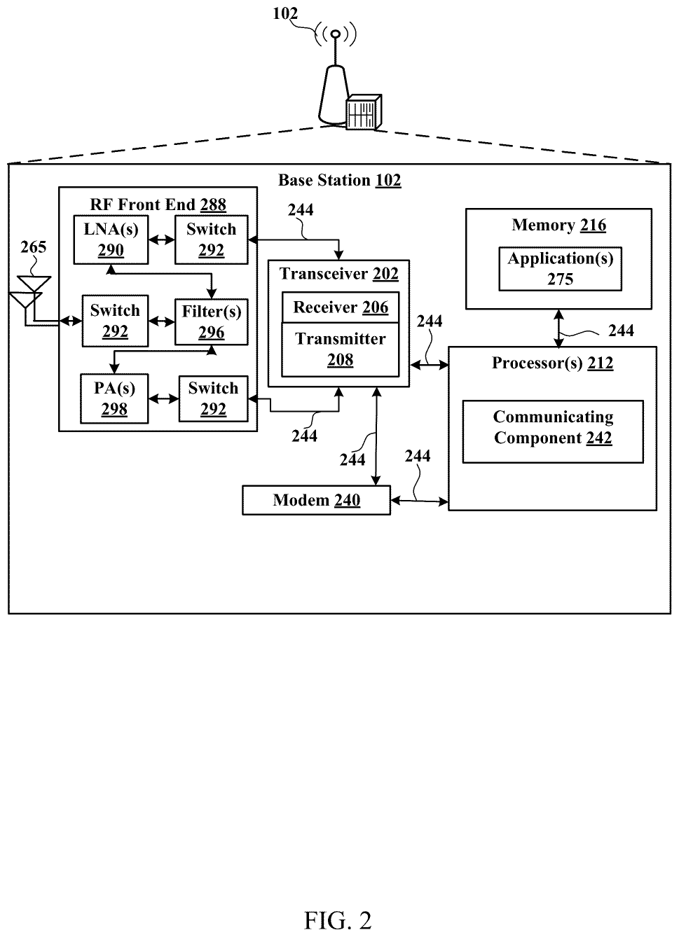

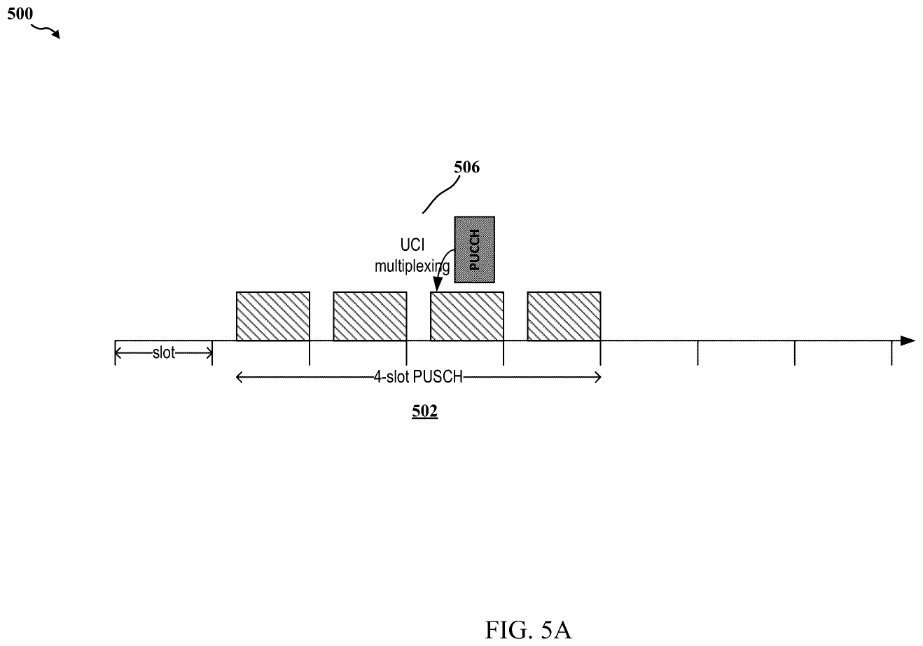

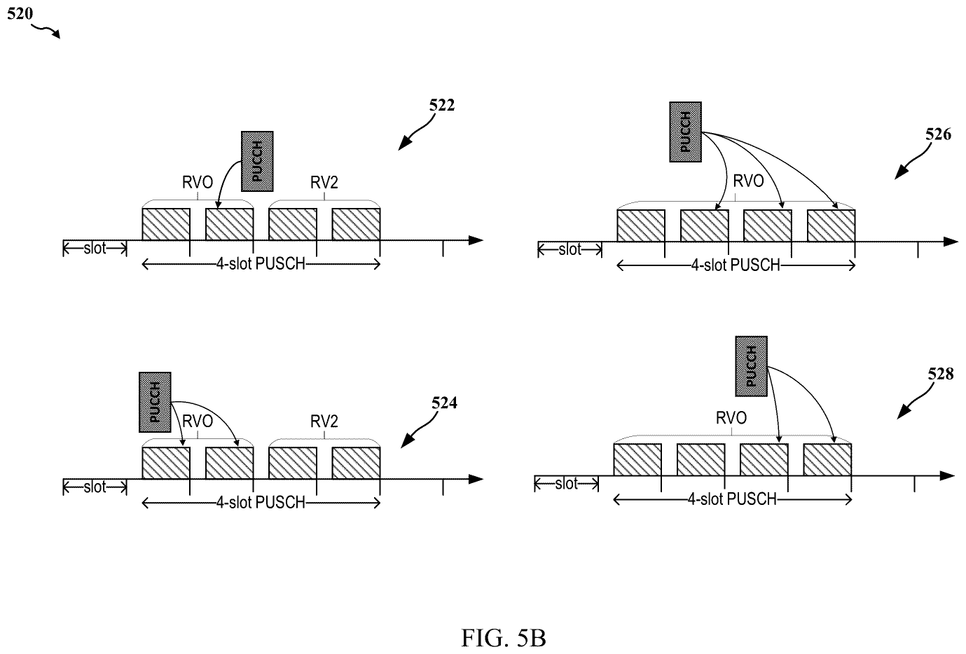

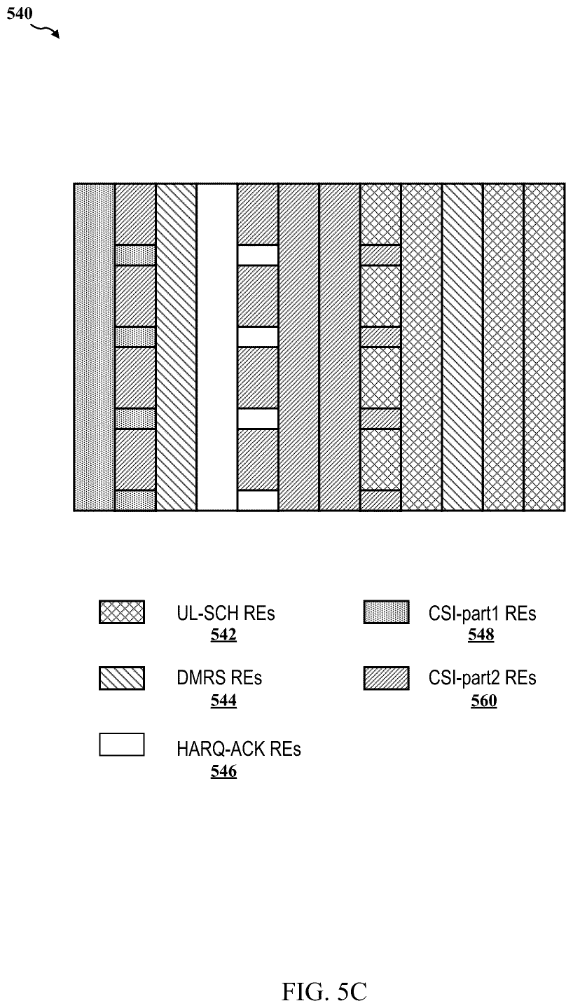

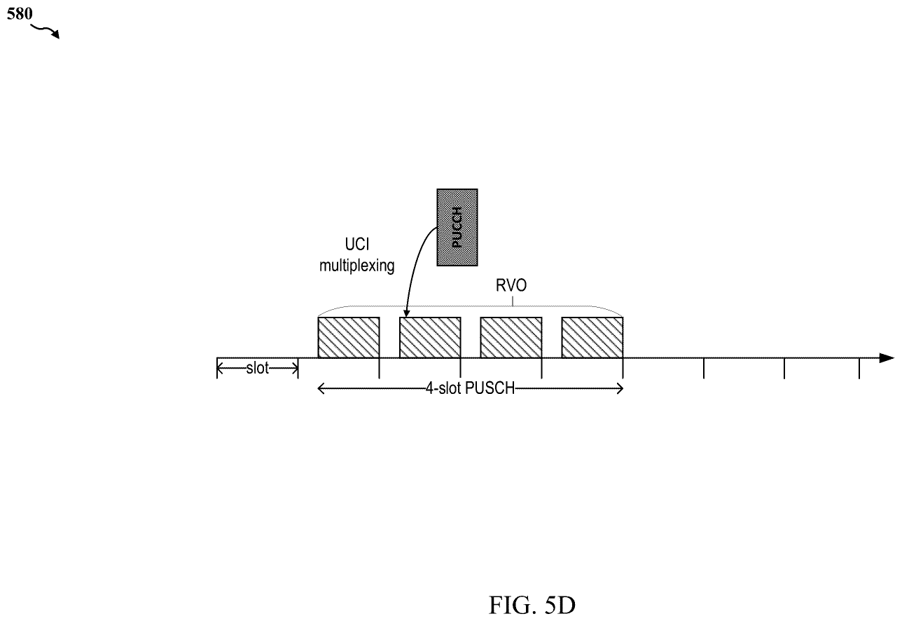

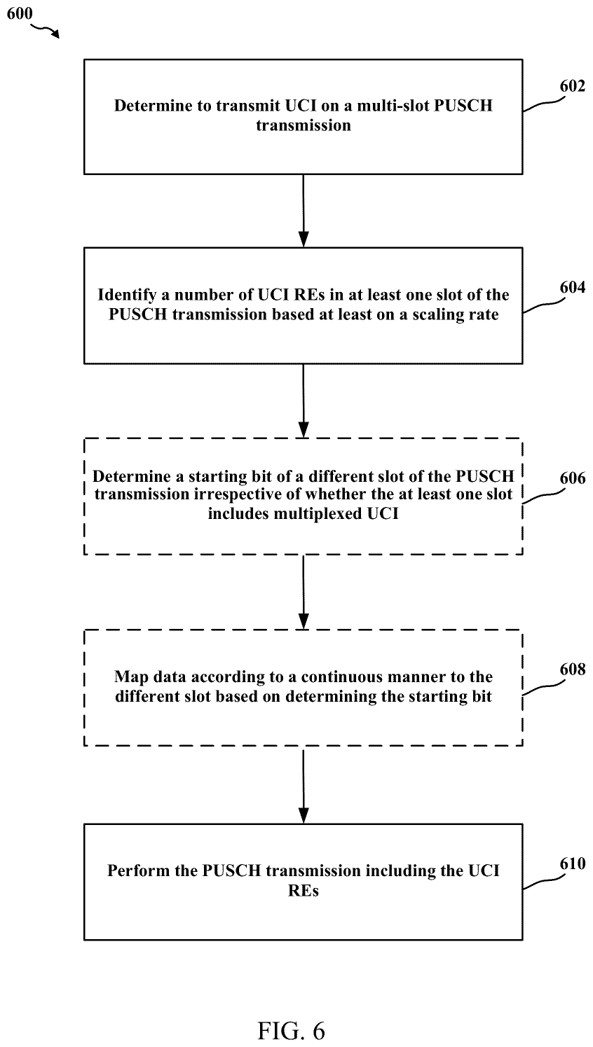

Turning now to FIGS. 2-7, aspects are depicted with reference to one or more components and one or more methods that may perform the actions or operations described herein, where aspects in dashed line may be optional. Although the operations described below in FIGS. 5 and 6 are presented in a particular order or as being performed by an example component, it should be understood that the ordering of the actions and the components performing the actions may be varied, depending on the implementation. Moreover, it should be understood that the following actions, functions, or described components may be performed by a specially-programmed processor, a processor executing specially-programmed software or computer-readable media, or by any other combination of a hardware component or a software component capable of performing the described actions or functions.

FIG. 2 is a block diagram illustrating an example of a network entity (also referred to as a base station). The base station (such as a base station 102 or gNB 180, as described above) may include a variety of components, some of which have already been described above and are described further herein, including components such as one or more processors 212 and memory 216 and transceiver 202 in communication via one or more buses 244, which may operate in conjunction with modem 240 or communicating component 242.

In some aspects, the one or more processors 212 can include a modem 240 or can be part of the modem 240 that uses one or more modem processors. Thus, the various functions related to communicating component 242 may be included in modem 240 or processors 212 and, in some aspects, can be executed by a single processor, while in other aspects, different ones of the functions may be executed by a combination of two or more different processors. For example, in some aspects, the one or more processors 212 may include any one or any combination of a modem processor, or a baseband processor, or a digital signal processor, or a transmit processor, or a receiver processor, or a transceiver processor associated with transceiver 202. In other aspects, some of the features of the one or more processors 212 or modem 240 associated with communicating component 242 may be performed by transceiver 202.

Also, memory 216 may be configured to store data used herein or local versions of applications 275 or communicating component 242 or one or more of its subcomponents being executed by at least one processor 212. Memory 216 can include any type of computer-readable medium usable by a computer or at least one processor 212, such as random access memory (RAM), read only memory (ROM), tapes, magnetic discs, optical discs, volatile memory, non-volatile memory, and any combination thereof. In some aspects, for example, memory 216 may be a non-transitory computer-readable storage medium that stores one or more computer-executable codes defining communicating component 242 or one or more of its subcomponents, or data associated therewith, when base station 102 is operating at least one processor 212 to execute communicating component 242 or one or more of its subcomponents.

Transceiver 202 may include at least one receiver 206 and at least one transmitter 208. Receiver 206 may include hardware or software executable by a processor for receiving data, the code including instructions and being stored in a memory (such as computer-readable medium). Receiver 206 may be, for example, a radio frequency (RF) receiver. In some aspects, receiver 206 may receive signals transmitted by at least one base station 102. Additionally, receiver 206 may process such received signals, and also may obtain measurements of the signals, such as, but not limited to, Ec/Io, signal-to-noise ratio (SNR), reference signal received power (RSRP), received signal strength indicator (RSSI), etc. Transmitter 208 may include hardware or software executable by a processor for transmitting data, the code including instructions and being stored in a memory (such as computer-readable medium). A suitable example of transmitter 208 may including, but is not limited to, an RF transmitter.

Moreover, in some aspects, base station 102 may include RF front end 288, which may operate in communication with one or more antennas 265 and transceiver 202 for receiving and transmitting radio transmissions, for example, wireless communications transmitted by at least one base station 102 or wireless transmissions transmitted by UE 104. RF front end 288 may be connected to one or more antennas 265 and can include one or more low-noise amplifiers (LNAs) 290, one or more switches 292, one or more power amplifiers (PAs) 298, and one or more filters 296 for transmitting and receiving RF signals. The antennas 265 may include one or more antennas, antenna elements, or antenna arrays.

In some aspects, LNA 290 can amplify a received signal at a desired output level. In some aspects, each LNA 290 may have a specified minimum and maximum gain values. In some aspects, RF front end 288 may use one or more switches 292 to select a particular LNA 290 and its specified gain value based on a desired gain value for a particular application.

Further, for example, one or more PA(s) 298 may be used by RF front end 288 to amplify a signal for an RF output at a desired output power level. In some aspects, each PA 298 may have specified minimum and maximum gain values. In some aspects, RF front end 288 may use one or more switches 292 to select a particular PA 298 and its specified gain value based on a desired gain value for a particular application.

Also, for example, one or more filters 296 can be used by RF front end 288 to filter a received signal to obtain an input RF signal. Similarly, in some aspects, for example, a respective filter 296 can be used to filter an output from a respective PA 298 to produce an output signal for transmission. In some aspects, each filter 296 can be connected to a specific LNA 290 or PA 298. In some aspects, RF front end 288 can use one or more switches 292 to select a transmit or receive path using a specified filter 296, LNA 290, or PA 298, based on a configuration as specified by transceiver 202 or processor 212.

As such, transceiver 202 may be configured to transmit and receive wireless signals through one or more antennas 265 via RF front end 288. In some aspects, transceiver may be tuned to operate at specified frequencies such that UE 104 can communicate with, for example, one or more base stations 102 or one or more cells associated with one or more base stations 102. In some aspects, for example, modem 240 can configure transceiver 202 to operate at a specified frequency and power level based on the UE configuration of the UE 104 and the communication protocol used by modem 240.

In some aspects, modem 240 can be a multiband-multimode modem, which can process digital data and communicate with transceiver 202 such that the digital data is sent and received using transceiver 202. In some aspects, modem 240 can be multiband and be configured to support multiple frequency bands for a specific communications protocol. In some aspects, modem 240 can be multimode and be configured to support multiple operating networks and communications protocols. In some aspects, modem 240 can control one or more components of UE 104 (such as RF front end 288, transceiver 202) to enable transmission or reception of signals from the network based on a specified modem configuration. In some aspects, the modem configuration can be based on the mode of the modem and the frequency band in use. In another aspect, the modem configuration can be based on UE configuration information associated with UE 104 as provided by the network during cell selection or cell reselection.

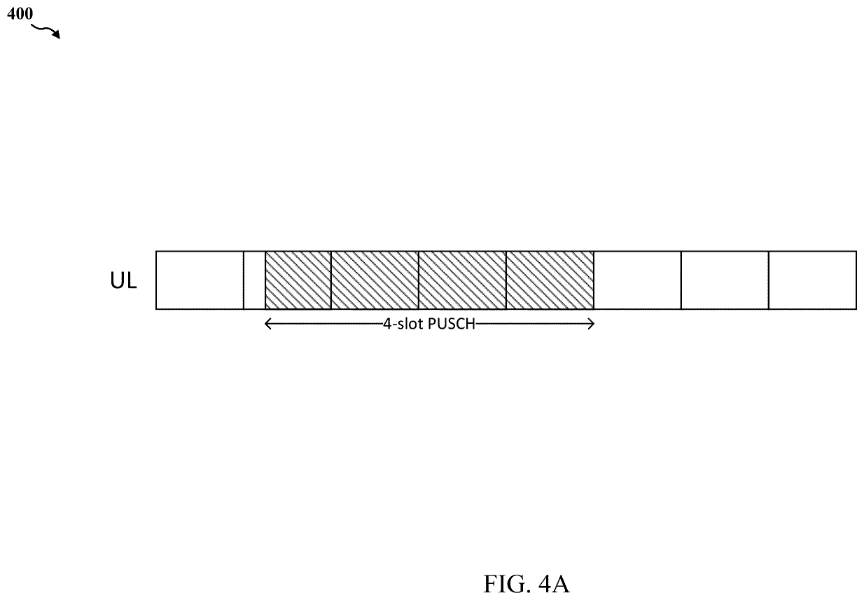

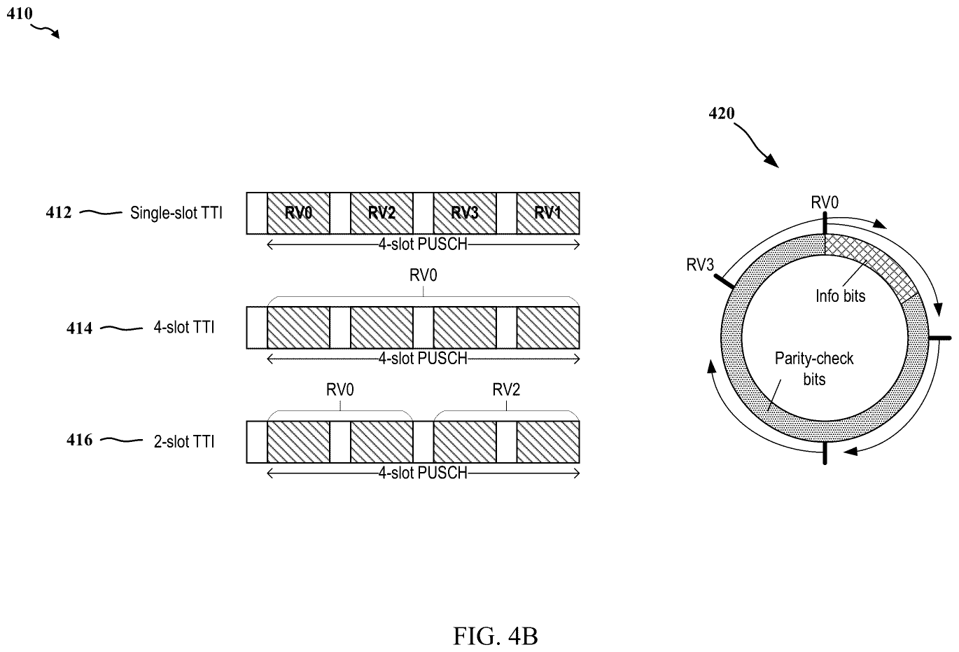

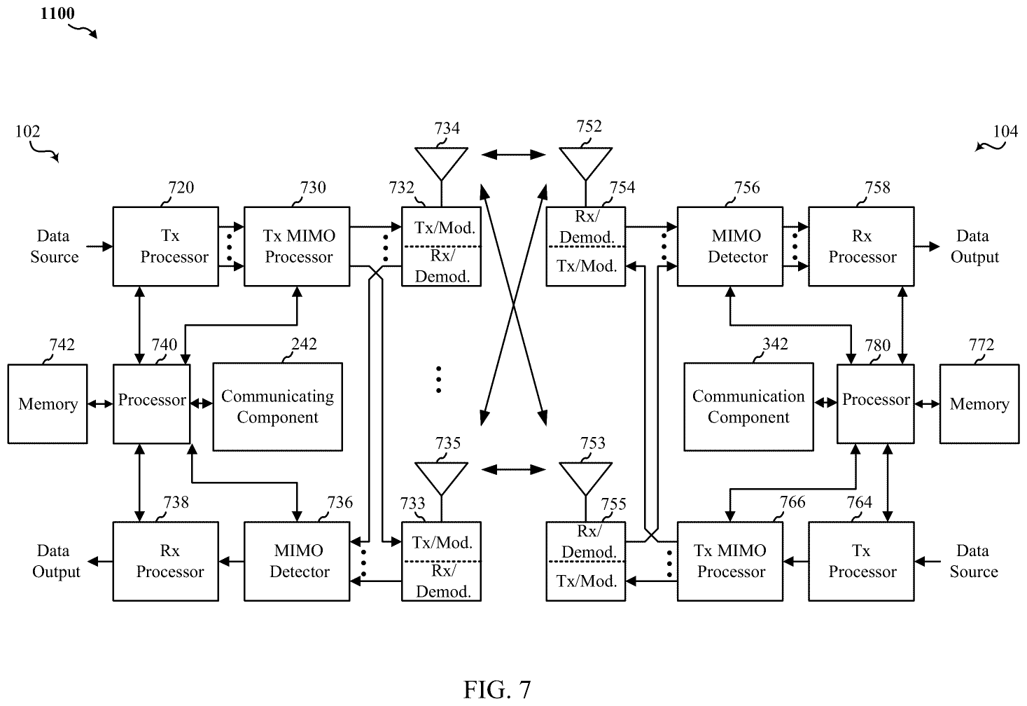

In some aspects, the processor(s) 212 may correspond to one or more of the processors described in connection with the UE in FIGS. 4 and 6. Similarly, the memory 216 may correspond to the memory described in connection with the UE in FIG. 7.

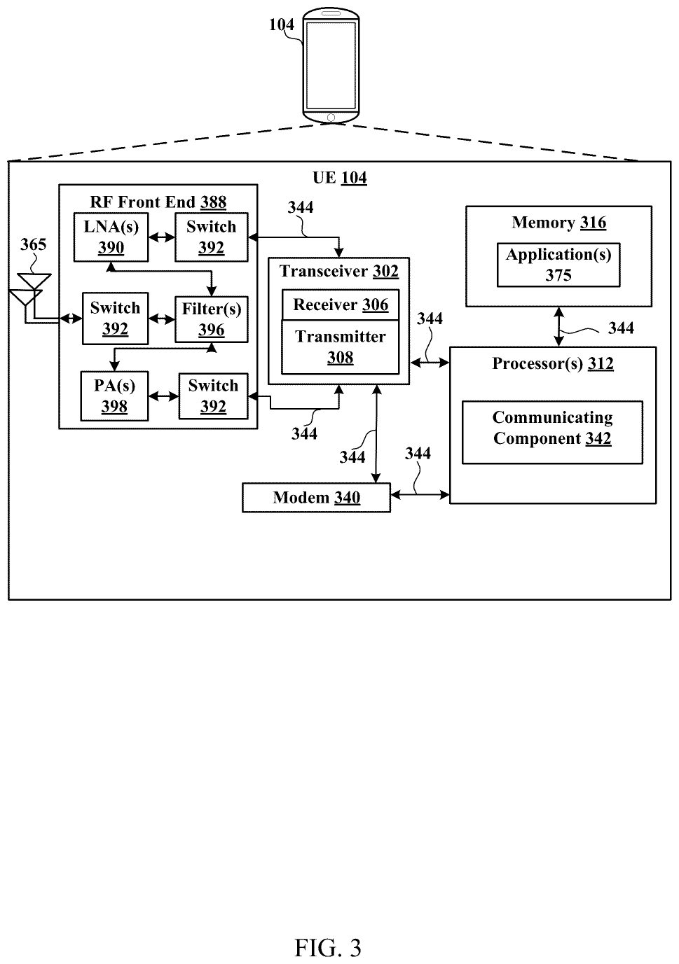

FIG. 3 is a block diagram illustrating an example of a UE 104. The UE 104 may include a variety of components, some of which have already been described above and are described further herein, including components such as one or more processors 312 and memory 316 and transceiver 302 in communication via one or more buses 344, which may operate in conjunction with modem 340 or communicating component 342 for multiplexing UCI with a multi-slot PUSCH transmission based on a scaling rate.

The transceiver 302, receiver 306, transmitter 308, one or more processors 312, memory 316, applications 375, buses 344, RF front end 388, LNAs 390, switches 392, filters 396, PAs 398, and one or more antennas 365 may be the same as or similar to the corresponding components of base station 102, as described above, but configured or otherwise programmed for base station operations as opposed to base station operations.

In some aspects, the processor(s) 312 may correspond to one or more of the processors described in connection with the base station in FIG. 7. Similarly, the memory 316 may correspond to the memory described in connection with the base station in FIG. 7.

FIG. 4A is an example representation of a multi-slot PUSCH 400 for uplink transmission by a UE such as UE 104, FIGS. 1, 3, and 7. In some aspects, each slot may have the same or similar time domain resources. Specifically, in 5G new radio (NR), repeated transmission of PUSCH over successive slots (i.e., slot-repetition, aggregation, or multi-slot PUSCH) may be supported to increase the signal-to-noise ratio (SNR) for transmission reliability. For example, the modulation and coding scheme (MCS) and resource allocation may be indicated in scheduling downlink control information (DCI), and may be common over the successive slots. Further, the number of slots may be radio resource control (RRC) configured (e.g., 2, 4, or 8 slots), and may be common for each scheduling (i.e., no distinction between a new transmission or a retransmission).

For each slot of the multi-slot PUSCH, the transmission block (TB) may be the same, but the encoded bits can differ such that the redundancy version (RV) of each slot can be different. For instance, the RV of a first slot may be indicated in the scheduling DCI, while the RV of another slot (n) may be determined by ‘n mod 4’. In some implementations, an example RV over slots for a new transmission of a 4-slot PDSCH may include RV0, RV2, RV3, and RV1. Another example RV over slots of a new retransmission of a 4-slot PDSCH may include RV3, RV1, RV0, and RV2. Further, a PUSCH repetition may be applied to coverage limited scenario.

FIG. 4B is an example representation of multiple transmit time interval (TTI) slot formats 410 and a RV mapping 420. For RV mapping 420, the starting bit of each RV may be defined at the corresponding location of the low-density parity-check (LDPC) encoded bits. For example, the multiple TTI slot formats 410 may include a single slot TTI 412, a 4 slot TTI 414, and a 2 slot TTI 416. For multi-slot PUSCH with TBS or MCS scaling up by an integer number (e.g., 2 or 4), the transmission performance may be similar to multi-slot TTI, only differentiated in whether the mapping of encoded bits are RV mapping 412 or continuous mapping 414 in each slot. For example, as shown, a 4-slot PUSCH with a single-slot TTI and slot-repetition 412, 4-slot TTI 414 (e.g., MCS or TBS scaled up by 4), or a hybrid with 2-slot TTI and repetition 416 (e.g., MCS or TBS scaled up by 2) may be implemented. In some aspects, TBS or MCS scaling may not be coupled with multi-slot TTI, i.e., the mapping of the multi-slot PUSCH with a TBS or MCS scaling can be either RV mapping or continuous mapping.

FIG. 5A illustrates an example PUSCH transmission scenario 500 of UCI 506 multiplexed on a PUSCH 502. Specifically, for a rate matching of UCI on PUSCH, a code rate scaling factor β_{offset}^{PUSCH}≥1 may be used to obtain a lower code rate one indicated by MCS. Further, to prevent the UCI occupying excessive resources of the PUSCH such that that the uplink shared channel (UL-SCH) includes too few REs, a portion factor α∈{0.5, 0.65, 0.8, 1.0} may be pre-configured to limit the max portion of resources that UCI can occupy according to:

$${Q}_{UCI}^{′} = min ( ⌈ \frac{{K}_{UCI} \cdot {β}_{offset}}{{K}_{UL - SCH}} {N}_{R E} ⌉ , ⌈ α \cdot {N}_{R E} ⌉ )$$

Where N_{RE} is the total number of REs per layer of the PUSCH in one slot that UCI can be mapped to, K_{UL-SCH} is the payload size of UL-SCH including TBS and TB CRC bits (e.g., also CB CRC bits if any), and K_{UCI} is the number of UCI payload size including CRC bits, if any. In some aspects, different types of UCI such as hybrid automatic repeat request acknowledgment (HARQ-ACK), channel state information part 1 (CSI-part1) or CSI-part2) may be separately encoded and rate-matched on PUSCH, and the values of β_{offset} may separately be configured for HARQ-ACK, CSI-part1 and CSI-part2. However, for multi-slot PUSCH with TBS or MCS scaling, the TBS may be scaled up (K_{UL-SCH} increases in value), which in turn results in the number of UCI REs decreasing, thereby causing loss for UCI transmission reliability on PUSCH.

As such, the present aspects may provide for UCI to be multiplexed on a multi-slot PUSCH transmission with a TBS or code rate scaling rate γ>1, with the number of REs UCI occupies determined by the scaling rate (γ). In one example, the UCI may be multiplexed on the PUSCH transmission at the same slot, and the number of UCI REs in the PUSCH transmission in that slot for HARQ-ACK, CSI-part1 and CSI-part2 respectively may be determined according to:

$${Q}_{UCI}^{′} = min ( ⌈ \frac{{K}_{UCI} \cdot {β}_{offset}}{{K}_{UL - SCH}} {N}_{R E} ⌉ , ⌈ α \cdot {N}_{R E} ⌉ )$$

The scenario involving partial overlap of a PUSCH with a PUCCH may be one case for UCI multiplexing on PUSCH. Another case can be, for example, directly scheduling an aperiodic CSI report on PUSCH where the UCI may not be associated with a PUCCH. In other words, aperiodic CSI report may be triggered on a multi-slot PUSCH, where the UCI may be multiplexed on a first slot transmission of the multi-slot PUSCH. Hence, in one implementation, the aperiodic CSI may be multiplexed on a first slot of the PUSCH.

FIG. 5B illustrates various example UCI multiplexing scenarios 520 for different scaling rates. For the case of a scaling rate (γ) equaling 2, a first scenario 522 and second scenario 524 may include the UCI multiplexed on the remaining slots of the PUSCH transmission as shown. For the case of a scaling rate (γ) equaling 4, a third scenario 526 and fourth scenario 528 may include the UCI multiplexed on the remaining slots of the PUSCH transmission as shown. Specifically,

the UCI may be multiplexed on the PUSCH transmission(s) at the remaining slot(s) of the γ slot unit (TTI), and the number of UCI REs in the PUSCH transmission(s) in each remaining slot for HARQ-ACK, CSI-part1 and CSI-part2 respectively, according to:

$${Q}_{UCI}^{′} = min ( ⌈ \frac{{K}_{UCI} \cdot {β}_{offset}}{{K}_{UL - SCH}} {N}_{R E} ⌉ , ⌈ α \cdot {N}_{R E} ⌉ )$$

Where Mₙₒₙ₋ₚᵣᵢₒᵣᵢ is the number of slots not priori to the slot of the PUCCH. As such, aperiodic CSI report may be triggered on a multi-slot PUSCH, where the UCI may be multiplexed on all the transmissions of all the slot of the multi-slot PUSCH, i.e., Mₙₒₙ₋ₚᵣᵢₒᵣᵢ is the number of slots of the multi-slot PUSCH.

FIG. 5C illustrates an example rate matching pattern 540 for a transmission in a slot. For instance, the rate matching pattern may include UL-SCH REs 542, demodulation reference signal (DMRS) REs 544, HARQ-ACK REs 546, CSI-part1 REs 548, and CSI-part2 REs 560. In particular, for the mapping of each type of UCI (e.g., HARQ-ACK, CSI-part1 and CSI-part2) on the remaining transmissions, in one aspect, the encoded bits of HARQ-ACK, CSI-part1 and CSI-part2, may be divided equally by the number of remaining transmissions respectively, and then mapped on each transmission, which may result in a more reliable HARQ-ACK for a DMRS symbol. The equal division can be semi-equal due to rounding operations (e.g. the encoded bits of each division may be an integer number of modulation order Qₘ). In another aspect, sequential mapping of HARQ-ACK, CSI-part1 and CSI-part2 over slots may be implemented to trigger early feedback of HARQ-ACK.

FIG. 5D illustrates an example UCI multiplexing scheme for a continuous mapping scenario 580. Specifically, the starting bit of a PUSCH transmission may not depend on whether UCI resources are multiplexed on a PUSCH transmission in a previous slot. That is, the starting bit of each PUSCH transmission in each slot may be determined similarly to the case with no UCI multiplexing on any transmission in any slot, even for continuous mapping. For example, the starting bit mapping of the PUSCH transmission in a third or fourth slot may not depend on whether UCI is multiplexed on a PUSCH transmission in the a second slot. Such feature may prevent the re-preparing procedure for a PUSCH transmission due to re-rate matching.

FIG. 6 is a flowchart of an example method 600 of wireless communication at an apparatus of a UE. In an example, a UE 104 can perform the functions described in method 600 using one or more of the components described in FIGS. 1, 3 and 7.

At block 602, the method 600 may determine to transmit UCI on a multi-slot PUSCH transmission. In some aspects, the communicating component 342, such as in conjunction with processor(s) 312, memory 316, or transceiver 302, may be configured to determine to transmit UCI on a multi-slot PUSCH transmission. Thus, the UE 104, the processor(s) 312, the communicating component 342 or one of its subcomponents may define the means for determining to transmit UCI on a multi-slot PUSCH transmission.

At block 604, the method 600 may identify a number of UCI REs in at least one slot of the PUSCH transmission based at least on a scaling rate. In some aspects, the communicating component 342, such as in conjunction with processor(s) 312, memory 316, or transceiver 302, may be configured to identify a number of UCI REs in at least one slot of the PUSCH transmission based at least on a scaling rate. Thus, the UE 104, the processor(s) 312, the communicating component 342 or one of its subcomponents may define the means for identifying a number of UCI REs in at least one slot of the PUSCH transmission based at least on a scaling rate.

In some implementations, the scaling rate may satisfy a scaling rate threshold value corresponding to a value greater than one.

In some implementations, the scaling rate may correspond to an integer or non-integer value greater than one.

In some implementations, the at least one slot may overlap in a time domain with a slot of the PUCCH.

In some implementations, the at least one slot may be a first slot of the PUSCH transmission including a scheduled aperiodic CSI.

In some implementations, the number of REs may further be identified based on a number of non-priori slots of the multi-slot PUSCH transmission.

In some implementations, performing the PUSCH transmission may include allocating a set of bits of the UCI by a number corresponding to the at least one slot, and mapping the UCI to the PUSCH transmission.

In some implementations, the set of bits may be allocated equally or semi-equally according to the number corresponding to the at least one slot.

In some implementations, identifying the number of UCI REs may include a sequentially mapping of the UCI to the at least one slot.

In some implementations, the UCI corresponds to at least one of a HARQ-ACK, CSI-Part 1, or CSI-Part 2.

At block 606, the method 600 may determine a starting bit of a different slot of the PUSCH transmission irrespective of whether the at least one slot includes multiplexed UCI. In some aspects, the communicating component 342, such as in conjunction with processor(s) 312, memory 316, or transceiver 302, may be configured to determine a starting bit of a different slot of the PUSCH transmission irrespective of whether the at least one slot includes multiplexed UCI. Thus, the UE 104, the processor(s) 312, the communicating component 342 or one of its subcomponents may define the means for determining a starting bit of a different slot of the PUSCH transmission irrespective of whether the at least one slot includes multiplexed UCI.

At block 608, the method 600 may map data according to a continuous manner to the different slot based on determining the starting bit. In some aspects, the communicating component 342, such as in conjunction with processor(s) 312, memory 316, or transceiver 302, may be configured to map data according to a continuous manner to the different slot based on determining the starting bit. Thus, the UE 104, the processor(s) 312, the communicating component 342 or one of its subcomponents may define the means for mapping data according to a continuous manner to the different slot based on determining the starting bit.

In some implementations, method 600 may determine a starting bit of a different slot of the PUSCH transmission according to a continuous manner such that the starting bit is irrespective of whether the at least one slot includes multiplexed UCI.

At block 610, the method 600 may perform the PUSCH transmission including the UCI REs. In some aspects, the communicating component 342, such as in conjunction with processor(s) 312, memory 316, or transceiver 302, may be configured to perform the PUSCH transmission including the UCI REs. Thus, the UE 104, the processor(s) 312, the communicating component 342 or one of its subcomponents may define the means for performing the PUSCH transmission including the UCI REs.

FIG. 7 is a block diagram of a MIMO communication system 700 including a base station 102 and a UE 104. The MIMO communication system 700 may be configured to multiplex UCI with a multi-slot PUSCH transmission based on a scaling rate, described herein. The MIMO communication system 700 may illustrate aspects of the wireless communication access network 100 described with reference to FIG. 1. The base station 102 may be an example of aspects of the base station 102 described with reference to FIG. 1. The base station 102 may be equipped with antennas 734 and 735, and the UE 104 may be equipped with antennas 752 and 753. In the MIMO communication system 700, the base station 102 may be able to send data over multiple communication links at the same time. Each communication link may be called a “layer” and the “rank” of the communication link may indicate the number of layers used for communication. For example, in a 2×2 MIMO communication system where base station 102 transmits two “layers,” the rank of the communication link between the base station 102 and the UE 104 is two.

At the base station 102, a transmit (Tx) processor 720 may receive data from a data source. The transmit processor 720 may process the data. The transmit processor 720 also may generate control symbols or reference symbols. A transmit MIMO processor 730 may perform spatial processing (such as precoding) on data symbols, control symbols, or reference symbols, if applicable, and may provide output symbol streams to the transmit modulator/demodulators 732 and 733. Each modulator/demodulator 732 through 733 may process a respective output symbol stream (such as for OFDM, etc.) to obtain an output sample stream. Each modulator/demodulator 732 through 733 may further process (such as convert to analog, amplify, filter, and upconvert) the output sample stream to obtain a DL signal. In one example, DL signals from modulator/demodulators 732 and 733 may be transmitted via the antennas 734 and 735, respectively.

The UE 104 may be an example of aspects of the UEs 104 described with reference to FIGS. 1 and 2. At the UE 104, the UE antennas 752 and 753 may receive the DL signals from the base station 102 and may provide the received signals to the modulator/demodulators 754 and 755, respectively. Each modulator/demodulator 754 through 755 may condition (such as filter, amplify, downconvert, and digitize) a respective received signal to obtain input samples. Each modulator/demodulator 754 through 755 may further process the input samples (such as for OFDM, etc.) to obtain received symbols. A MIMO detector 756 may obtain received symbols from the modulator/demodulators 754 and 755, perform MIMO detection on the received symbols, if applicable, and provide detected symbols. A receive (Rx) processor 758 may process (such as demodulate, deinterleave, and decode) the detected symbols, providing decoded data for the UE 104 to a data output, and provide decoded control information to a processor 780, or memory 782.

The processor 780 may in some cases execute stored instructions to instantiate a communicating component 242 (see such as FIGS. 1 and 2).

On the uplink (UL), at the UE 104, a transmit processor 764 may receive and process data from a data source. The transmit processor 764 also may generate reference symbols for a reference signal. The symbols from the transmit processor 764 may be precoded by a transmit MIMO processor 766 if applicable, further processed by the modulator/demodulators 754 and 755 (such as for SC-FDMA, etc.), and be transmitted to the base station 102 in accordance with the communication parameters received from the base station 102. At the base station 102, the UL signals from the UE 104 may be received by the antennas 734 and 735, processed by the modulator/demodulators 732 and 733, detected by a MIMO detector 736 if applicable, and further processed by a receive processor 738. The receive processor 738 may provide decoded data to a data output and to the processor 740 or memory 742.

The components of the UE 104 may, individually or collectively, be implemented with one or more ASICs adapted to perform some or all of the applicable functions in hardware. Each of the noted modules may be a means for performing one or more functions related to operation of the MIMO communication system 700. Similarly, the components of the base station 102 may, individually or collectively, be implemented with one or more ASICs adapted to perform some or all of the applicable functions in hardware. Each of the noted components may be a means for performing one or more functions related to operation of the MIMO communication system 700.

An Appendix is included that is part of the present application and provides additional details related to the various aspects of the present disclosure.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

1. A method of communication at a user equipment (UE), comprising:
determining to transmit uplink control information (UCI) on a multi-slot physical uplink shared channel (PUSCH) transmission;
identifying a number of UCI resource elements (REs) in at least one slot of the PUSCH transmission based at least on a scaling rate; and
performing the PUSCH transmission including the UCI REs.

2. The method of claim 1, wherein the scaling rate satisfies a scaling rate threshold value corresponding to a value greater than one.

3. The method of claim 2, wherein the scaling rate corresponds to an integer or non-integer value greater than one.

4. The method of claim 1, wherein the at least one slot of the PUSCH transmission overlaps in a time domain with a physical uplink control channel (PUCCH).

5. The method of claim 1, wherein the at least one slot is a first slot of the PUSCH transmission including a triggered aperiodic channel state information (CSI).

6. The method of claim 1, further comprising:
determining a starting bit of a different slot of the PUSCH transmission irrespective of whether the at least one slot includes multiplexed UCI; and
mapping data according to a continuous manner to the different slot based on determining the starting bit.

6. (canceled)

7. The method of claim 1, wherein performing the PUSCH transmission includes:
allocating a set of bits of the UCI by a number corresponding to the at least one slot; and
mapping the UCI to the PUSCH transmission.

8. The method of claim 7, wherein the set of bits are allocated equally or semi-equally according to the number corresponding to the at least one slot.

9. The method of claim 1, wherein identifying the number of UCI REs includes a sequentially mapping of the UCI to the at least one slot.

10. The method of claim 1, wherein the UCI corresponds to at least one of a hybrid automatic repeat request acknowledgment (HARQ-ACK), channel state information part 1 (CSI-Part 1), or CSI-Part 2.

11.-13. (canceled)

14. The method of claim 1, wherein the number of REs is further identified based on a number of non-priori slots of the multi-slot PUSCH transmission.

15. An apparatus for wireless communication, comprising:
a transceiver;
a memory configured to store instructions; and
at least one processor communicatively coupled with the transceiver and the memory, wherein the at least one processor is configured to:
determine to transmit uplink control information (UCI) on a multi-slot physical uplink shared channel (PUSCH) transmission;
identify a number of UCI resource elements (REs) in at least one slot of the PUSCH transmission based at least on a scaling rate; and
perform the PUSCH transmission including the UCI REs.

16. The apparatus of claim 15, wherein the scaling rate satisfies a scaling rate threshold value corresponding to a value greater than one.

17. The apparatus of claim 16, wherein the scaling rate corresponds to an integer or non-integer value greater than one.

18. The apparatus of claim 15, wherein the at least one slot of the PUSCH transmission overlaps in a time domain with a physical uplink control channel (PUCCH).

19. The apparatus of claim 15, wherein the at least one slot is a first slot of the PUSCH transmission including a triggered aperiodic channel state information (CSI).

20. The apparatus of claim 15, wherein the at least one processor is further configured to:
determine a starting bit of a different slot of the PUSCH transmission irrespective of whether the at least one slot includes multiplexed UCI; and
map data according to a continuous manner to the different slot based on determining the starting bit.

21. The apparatus of claim 15, wherein the number of REs is further identified based on a number of non-priori slots of the multi-slot PUSCH transmission.

22. The apparatus of claim 15, wherein to perform the PUSCH transmission, the at least one processor is further configured to:
allocate a set of bits of the UCI by a number corresponding to the at least one slot; and
map the UCI to the PUSCH transmission.

23. The apparatus of claim 22, wherein the set of bits are allocated equally or semi-equally according to the number corresponding to the at least one slot.

24. The apparatus of claim 15, wherein the identification of the number of UCI REs includes a sequential mapping of the UCI to the at least one slot.

25. The apparatus of claim 15, wherein the UCI corresponds to at least one of a hybrid automatic repeat request acknowledgment (HARQ-ACK), channel state information part 1 (CSI-Part 1), or CSI-Part 2.

26. An apparatus for wireless communication, comprising:
means for determining to transmit uplink control information (UCI) on a multi-slot physical uplink shared channel (PUSCH) transmission;
means for identifying a number of UCI resource elements (REs) in at least one slot of the PUSCH transmission based at least on a scaling rate; and
means for performing the PUSCH transmission including the UCI REs.
